(19) United States
(12) Patent Application Publication
(10) Pub. No.: US 2008/0284178 A1
(43) Pub. Date: Nov. 20, 2008

(54) Method of Generating Electricity and Device for Generating Electricity by Utilizing the Lifting Force of the Water

(76) Inventor: Dinh Viet Pham, Ho Chi Minh City (VN)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/091,912

(22) PCT Filed: Oct. 25, 2006
(86) PCT No.: PCT/VN06/00008

§ 371 Date: Apr. 28, 2008

(30) Foreign Application Priority Data
Oct. 26, 2005 (VN) 1-2005-01568

(51) Int. Cl. F03B 17/02

(52) U.S. Cl. 290/1 R

(57) ABSTRACT

The present invention relates to a method of generating electricity by utilizing the lifting force of the water. The method comprises of the steps of submerging and anchoring an air filled sphere (1) under the water, wherein the Archimedean lifting force combine with water pressure to form an upwardly vertical force (F). The said force is imparted by a rotating shaft (2) to unit M spaced from the water surface at an appropriate distance. Force F is converted to the horizontal rotating force (F1 and F2) and is transmitted to a turbine of the electric generator (8). The present invention also relates to a device using the method. The device includes a flexible hollow sphere (1) connected to a rotating shaft (2). One end of the rotating shaft is a part of unit M which includes a plurality of bevel gears (M 1, M2, M I) meshed with each other. At unit M, the upwardly vertical force (F) is collected and transferred into the horizontal rotating forces, due to a system with horizontal rotating shafts and a driven rod, which are transmitted into a turbine of an electric generator (8). Unit M1 the system of the rotating shafts, and the electric generator are arranged on a platform (10) spaced from the surface of the water.

### FIELD OF THE INVENTION

The invention relates to a generation of power, in particular, to a method for generating of the electricity by means of utilizing the lifting force of the water, as well a device implementing such a method.

### BACKGROUND OF THE INVENTION

Up to date, various power resources, such as thermo-electricity, hydroelectricity and nuclear electricity are known and being used. Since fossil resources are running out, the construction of hydroelectricity plants are very expensive and cause damage to the environment, inhabitants, and nuclear reactors have a high risk of accident, it is necessary to find and use a clean power resource, such as wind electricity, solar-electricity or tide-electricity. However, for many various reasons, for example, wind changes, heat distribution, periods of time, and shortages of finance, the exploitation of clean power resources does not correspond to their potentials.

### SUMMARY OF THE INVENTION

Before the discovery of the Archimedean principle, the application of the hydrostatic force in the field of water movement was known. Since then, the application of the hydrostatic force has become more scientific and effective. It is apparent that the hydrostatic force is one of the inexhaustible power resources which are available in water, i.e., in rivers, lakes, and oceans. The present invention relates to the exploitation and the utilization of the Archimedean lifting force and water pressure by means of using a device for generating and collecting power, for subsequent use of rotating a turbine of an electric generator.

The invention provides a method, in which: a big sphere in the form of a water drop filled by air, which is submerged into water, is subject to the Archimedean lifting force and pressure, which applies to the surface thereof, provides the sphere with a upwardly vertical lifting force, and therefore makes the sphere floatable. In order to retain the sphere in water, i.e. maintain continuously the upwardly vertical lifting force, the present invention provides a vertical rotating shaft for imparting the force; this rotating shaft is fixed by the horizontal rotating shafts. The horizontal rotating shafts function not only as the fixing members for the vertical rotating shaft but also as the driving shafts. The ends of the horizontal rotating shafts and the vertical rotating shaft are provided with the cones having the helical recesses (or inclined recesses not shown), which are disposed side-by-side on the top of the cone engaged with each other. At the contact surface of the horizontal rotating shafts and vertical rotating shaft, the upwardly vertical lifting force is very large while the area of such a contact surface is very small, that is, the friction force is small. In a preferable embodiment, the rotating shafts are capable of rotating around their axis on a bearing such as a ball bearing, when the upwardly vertical lifting force is beyond the friction force at the contact surface, since the helical recesses are provided with a certain inclination, the friction force will be changed from static friction to sliding friction and finally turn into rolling friction force. The rolling friction force will displace the contact surface in the opposite direction of the helical recesses and rotate the horizontal rotating shafts in the same direction as the helical recesses, which are disposed side by side between the shafts and engaged with each other. Therefore, the upwardly vertical lifting force is converted into the force used for driving the rotating shafts. The rotation of the shafts will be transmitted to a turbine via a drive connection to generate the electricity.

### BRIEF DESCRIPTION OF THE DRAWINGS

FIG. 1 shows the diagram of collecting and redirecting the hydrostatical power according to the invention. The lifting force F is converged in M and divided into F1 and F2, and then it is collected and transmitted to a turbine of the electric generator.

FIG. 2 shows the diagram of device according to an embodiment of the invention, the device includes two main parts: a sphere for generating the lifting force and part M, used for collecting and redirecting the lifting force F.

FIG. 3 shows the diagram of the station for collecting and redirecting hydrostatic force according to an embodiment of the invention.

FIG. 4 shows the diagram of transmitting the hydrostatic force to a turbine of the electric generator.

FIG. 5 is a perspective view of the station for collecting the hydrostatical power and for generating electricity.

FIG. 6 shows the interior structure of a sphere when the supporting frame is in the collapsed state, and the sphere is not filled by air.

FIG. 7 shows the interior structure of a sphere when the supporting frames are in an operational state, in which the sphere is filled by air.

FIG. 8 is a side view of the supporting frame of the sphere according to the invention.

FIG. 9 is a front view of the supporting frame of the sphere according to the invention.

FIG. 10 is a plan view of the supporting frame of the sphere according to the invention.

FIG. 11 shows the fixing device M and the force imparting shafts.

FIG. 12 shows collar A.

FIG. 13 is a front view of device M.

FIG. 14 is a plan view of device M.

FIG. 15 is a side view of device M.

FIG. 16 is a plan view of the station for generating electricity by hydrostatic force; the station includes force imparting shafts, M device and a turbine of the electric generator.

### DETAILED DESCRIPTION OF THE INVENTION

Here, the description of the method collecting and redirecting the Archimedean lifting force, i.e., the hydrostatic force, and water pressure to generate electricity is provided with reference to FIG. 1. In principle, an article submerged in water is subject to the Archimedean lifting force which is vertically oriented upwardly, and its own gravity, which is oriented vertically downwardly. In order to buoy such an article up, its gravity must be less than the lifting force. Preferably, the submerged article is in the form of a sphere filled by air because its gravity is lowest.

In a submerging state, the sphere is subject to the Archimedean lifting force corresponding to the volume thereof, which generates force F acting on the sphere so as to buoy it up. When the sphere is submerged in water, it is also subject to water pressure acting on its surface, and such a pressure is the proportion to the distance from the sphere to the water surface. The deeper the sphere is submerged, the higher the pressure becomes, and thus the force F, generated by the Archimedean lifting force and the pressure of the water acting on the sphere is larger. According to the invention, since a vertical shaft connects to the sphere and maintains the sphere under the water, the lifting force F is imparted via shaft FI to unit M at MI. At unit M, the vertically lifting force F is transferred into the horizontally rotating forces F1 and F2 by means of the device according to the invention.

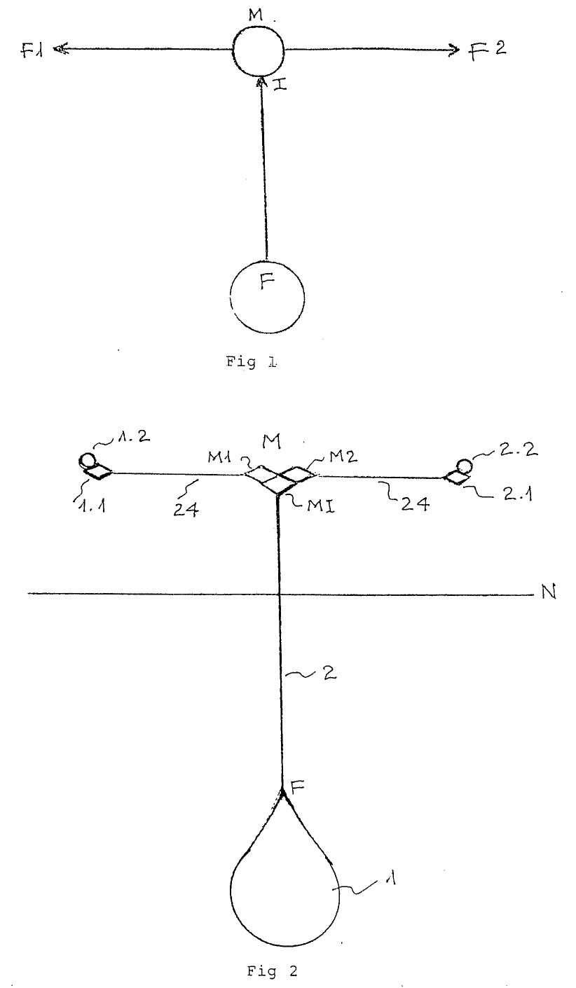

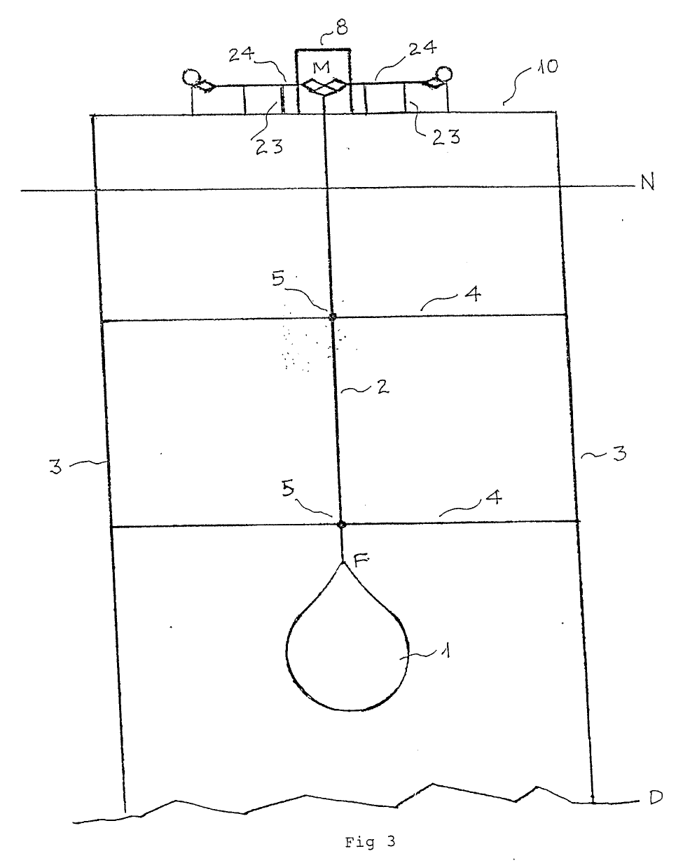

FIG. 2 shows a schematic view of the device for collecting and redirecting force F. Force F is the Archimedean lifting force acting on the air filled elastic sphere in the form of a drop of water. Force F is oriented in the vertical direction F1, which coincides with shaft 2 and is converged in MI. Shaft 2 functions not only as an anchor to maintain sphere 1 under the water and but also as a linkage rod to connect sphere 1 with unit M. Unit M includes the bevel gears MI, M1 and M2. Bevel gears M1 and M2 are connected to the connecting rods 24, having the bevel gears 1.1 and 2.1, in its turn, bevel gear 1.1 is orthogonally connected to 1.2, bevel gear 2.1 is orthogonally connected to 2.2. The rotating shafts M-1.1, M2-2.1 are formed by the connecting rods 24, which are supported by the ball bearings and kept in place by the collar and anchor shaft. All of these parts are arranged in an appropriate distance from the water surface N.

FIG. 3 shows the schematic view of the station for generating and collecting the force F. According to an embodiment of the invention, the station includes a frame having columns 3 which are fixed to the water base D, for example, the seabed. Columns 3 are linked to each other by supporting and damping rods 4, ball bearings 5 and the collars are disposed at the intersections of supporting and damping rods 4 to hold the rotating shaft 2. Platform 10 is disposed on the top of columns 3, which are in an appropriate distance from water surface N. The device for collecting the force F, system M for imparting the force and system 8 for generating and transmitting the electricity, is arranged on the surface of the platform. Sphere 1 is displacement article for generating the lifting force F under the water, and is attached to the rotating shaft 2 on the surface of the platform 10, the rotating shaft 2 is held by the collars and ball bearings 5 and the horizontal rotating shaft 24 is anchored by the anchored column 23.

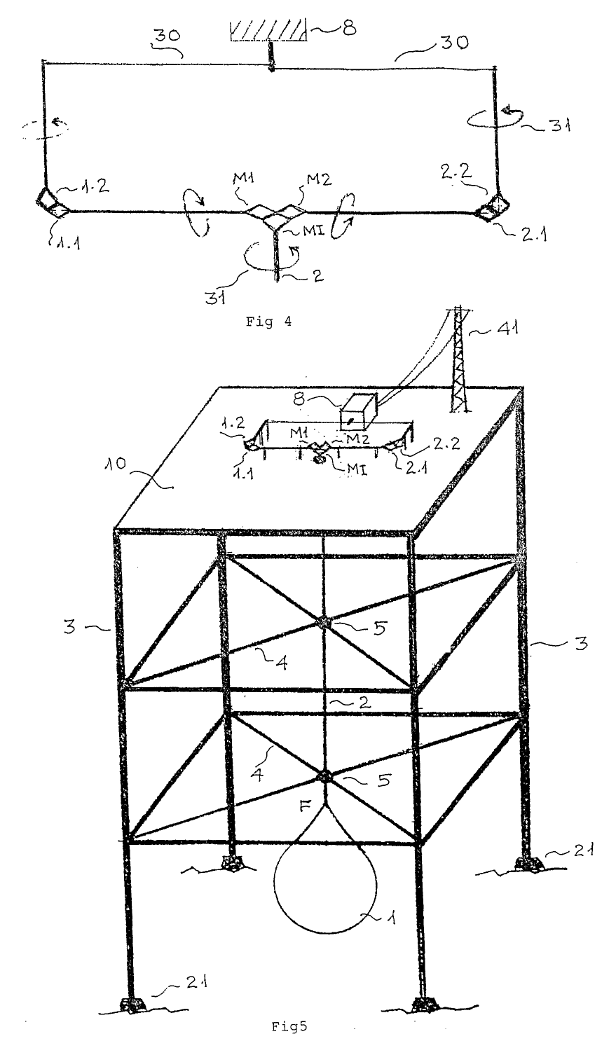

FIG. 4 shows the arrangement of the devices for collecting and generating electricity by imparting the force to a turbine of the electric generator, on the surface of the platform: unit M includes bevel gears MI, M1 and M2; in which M1 and M2 are meshed with MI, the other end of the rotating shaft having the bevel gear M1, is provided with the bevel gear 1-1, which is meshed with bevel gear 1-2. The other end of the rotating shaft having the bevel gear 1-2 is provided with a cylinder, to which a driven rod is connected, which is disposed orthogonally with the rotating shaft M1-1.1. Similarly, the other end of the rotating shaft, having the end provided with the bevel gear M2, is provided with the bevel gear 2-1. This bevel gear is meshed with bevel gear 2-2, the other end of the rotating shaft, having the end provided with the bevel gear 2-2, is provided with a cylinder, to which it is connected to a driven rod which is disposed orthogonally with the rotating shaft M2-2.1. The force imparted from the rotating shaft 2 to MI, will be stopped and transferred into M1 and M2, and simultaneously causes the rotations of MI, M1 and M2, so as to rotate all of the rotating shafts. The direction of the rotation 31 of the rotating shaft M1-1.1 is opposite to the direction of the rotation of the rotating shaft M2-2.1. However, in their turn, both of the rotating shafts, 1.2 and 2.2, rotate in the same direction. Therefore, two driven rods 30 can be simultaneously mounted to rotating shaft 1.2 and rotating shaft 2.2, to increase the force which is transmitted to turbine 8 for generating electricity.

The size of the platform and the device depend on the natural conditions of the sites, such as lakes, rivers or oceans. FIG. 5 is a perspective schematic view of the station collecting the force F for generating electricity, in which: reference number 1 denotes the sphere, which is filled by air, which is connected to the rotating shaft 2. The rotating shaft 2 includes a plurality of the rods, the number of which depends on the depth of the water. The rotating shafts are connected from sphere 1 through ball bearings 5 and the surface of the platform 10 to reach MI provided at the other end. Preferably, rotating shaft 2 is a hollow shaft, which contains the air pipes and electric wires of the motor. Reference numbers 3 denote the columns of the platform which are fixed to the base 21 at the bottom. Columns are linked to each other by the supporting and damping rods 4, ball bearings 5 are disposed at the intersection of the supporting and damping rods 4 to support the rotating shaft 2 in stability while rotating around their axis. Platform 10 mounted on the top of the columns 3, spaced from the water surface N at an appropriate distance, provides a surface for accommodating the operation devices, the rotating shafts MI, M1-1.1, M2-2.1 and 1.2;2.2; the turbine of electric generator 8 and a system for transmitting electricity 41.

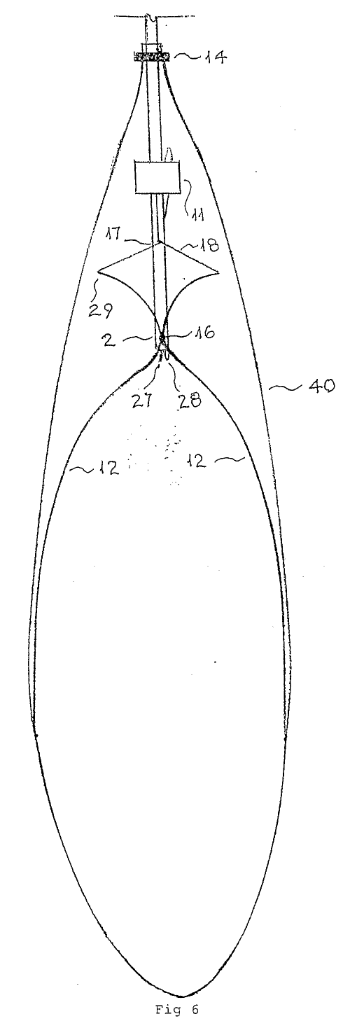

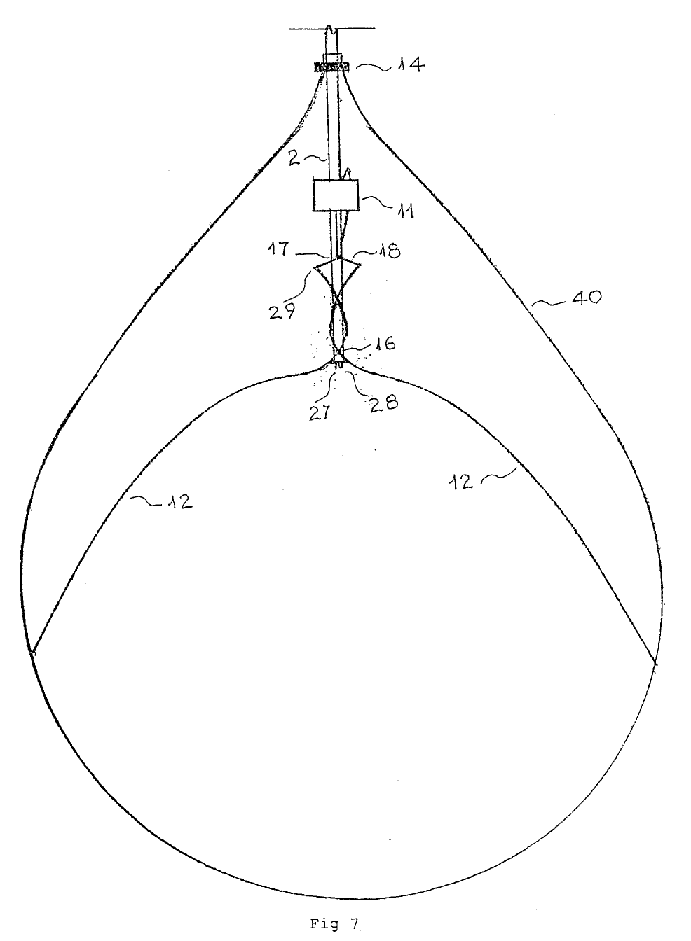

FIG. 6 shows the interior structure of the sphere when the supporting frame is in s collapsed state, in which the sphere is not filled by air, i.e. is in a collapsed condition. Reference number 2 denote a rotating shaft for imparting the lifting force from the sphere. Rotating shaft 2 functions as a connecting shaft for connecting the sphere to MI. Preferably, rotating shaft 2 is a hollow shaft to accommodate air pipes 27 of the sphere and electric wire 28 of the motor 11. Reference number 12 denotes supporting frames for connecting the sphere to rotating shaft 2 and facilitating the fill of the air. The number of the supporting frames depends on the size of the sphere. Reference number 16 denotes a horizontal rod, which is inserted through the holes provided on the supporting frame. Reference number 17 denote a pulley, and reference number 18 denotes a line for connecting the connecting rod 29 [linking the ends of the supporting frames 12 with each other] through the pulley 17 to the shaft of the motor 11. Reference number 14 denotes a collar for mounting the cover of the sphere to their rotating shaft 2. Reference number 40 denotes the elastic cover of the sphere.

FIG. 7 shows the details of the sphere when the motor 11 is activated in order to reduce the length of the line 18 via pulley 17 and therefore to expand the supporting frames 12; the air is filled via pipe 27 to swell out the sphere. In another embodiment, the length of the line 18 can be manually reduced. Reference number 16 denotes a horizontal rod, which is inserted through the holes provided in the supporting frame and which functions as a fulcrum for fixing the supporting frame in a fixed position on the horizontal rod while the two ends of the supporting frames can be displaced. Reference number 17 denotes a pulley for inserting the line which connects the connecting rod 29 to the shaft of the motor 11. Reference number 2 denotes the hollow rotating shaft for accommodating the air pipes 27 and electric wire 28 inside, reference number 14 denotes the collar for mounting the cover of the sphere 40 to the rotating shaft 2. Preferably, the cover of the sphere 40 can be made by elastic material with high durability.

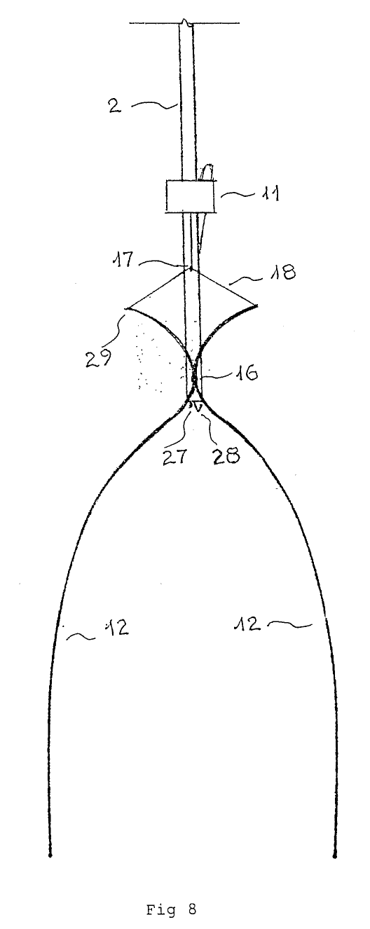

FIG. 8 shows the front view of the supporting frame of the sphere in a collapsed condition: reference number 2 denotes the hollow rotating shaft for accommodating the air pipes 27 and electric wire 28 of the motor 11. Horizontal rod 16, pulley 17, motor 11 and rotating shaft 2 are provided on shaft 2. Reference number 18 denotes the line for connecting the connecting rods 29 [which link the supporting frame 12] through pulley 17 to the shaft of the motor 11.

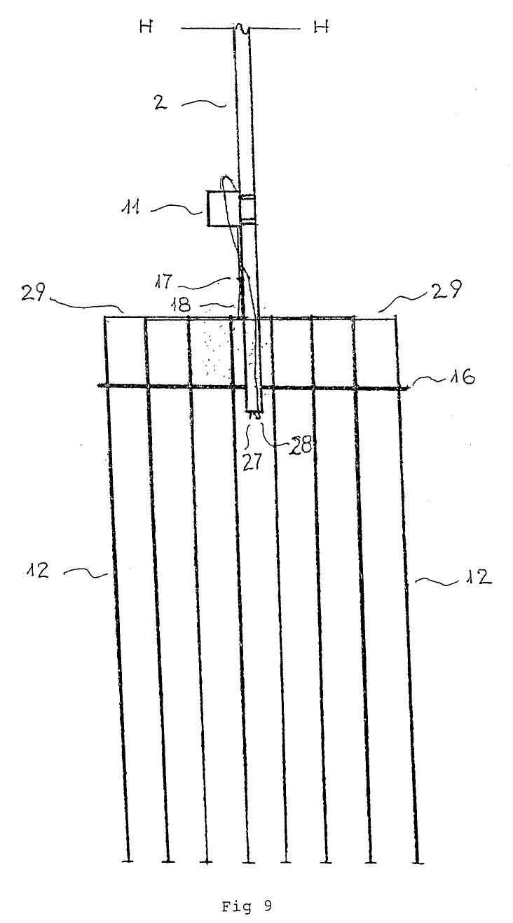

FIG. 9 is the side view of the supporting frame of the sphere in the collapsed condition. Reference number 2 denotes the rotating shaft accommodating air pipes 27 and electric wire 28, which supplies electricity to motor 11. Horizontal rod 16, pulley 17 and motor 11 are provided on rotating shaft 2. Reference number 18 denotes lines for connecting the connecting rod 29 [which link the supporting frames 12] through pulley 17 to the shaft of the motor 11, H-H is cross-section line of the rotating shaft 2.

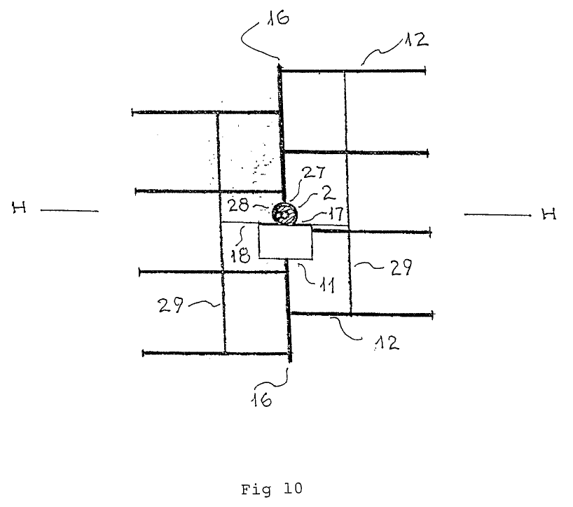

FIG. 10 shows the cross-section view along line H-H of the rotating shaft 2 and the plan view of the supporting frame. Reference number 11 denotes the motor, reference number 12 denotes the supporting frame, reference number 16 denotes the horizontal rod, reference number 18 denotes the line for connecting the connecting rod 29 of supporting frame 12 through pulley 17 to the shaft of motor 11; reference number 2 denotes the rotating shaft 2, reference number 27 denotes the air pipes, reference number 28 denotes the electric wire.

FIG. 11 shows the device for stopping and collecting lifting force F at unit M, and a part of the shafts imparting force. The device is shown at A′-A-B positions, in which: A′-A-B denote the positions of the anchored columns and the collar for holding the rotating shaft for imparting the force. Reference number 2 denotes rotating shaft imparting the lifting force from the sphere, reference number 5 denotes the collar and the ball bearing of the rotating shaft 2, MI denotes the bevel gear converging the force from the rotating shaft 2; M1 and M2 denote the bevel gears meshed with MI and receive the force imparted from MI, reference number 23 denotes the anchored of column rotating shaft 24, reference number 25 denotes the collars and ball bearing used for holding the rotating shaft 24.

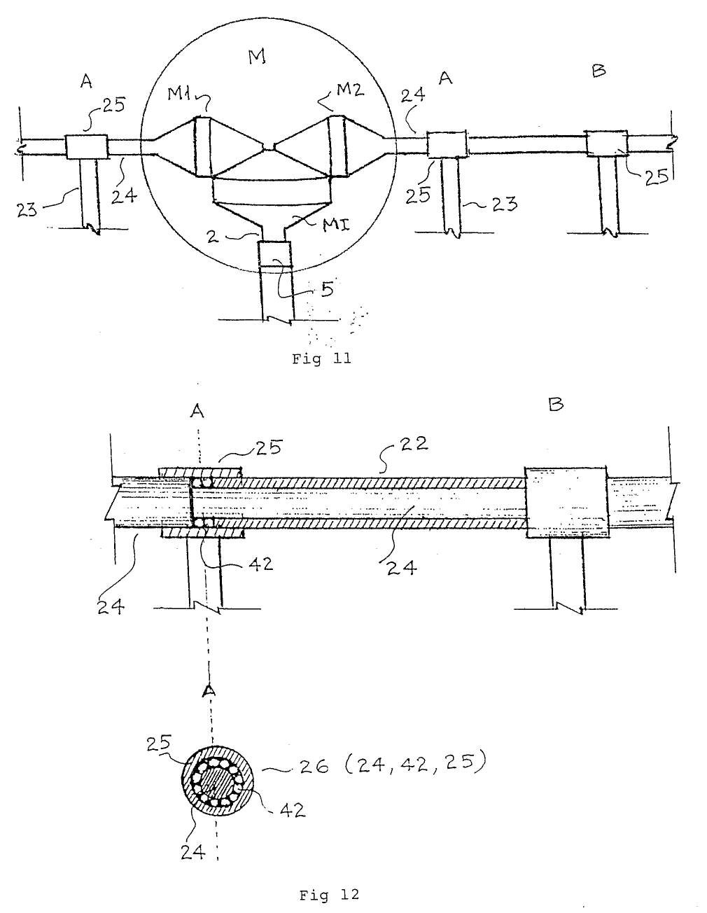

FIG. 12 shows the details of the cross section along line A-B of collar 25 and outer collar 22 of the rotating shaft 24, in which reference number 26 denotes the cross section of shaft 24 along line A-A and double ball bearing, including the rotating shaft 24, ball bearings 42 and collar 25.

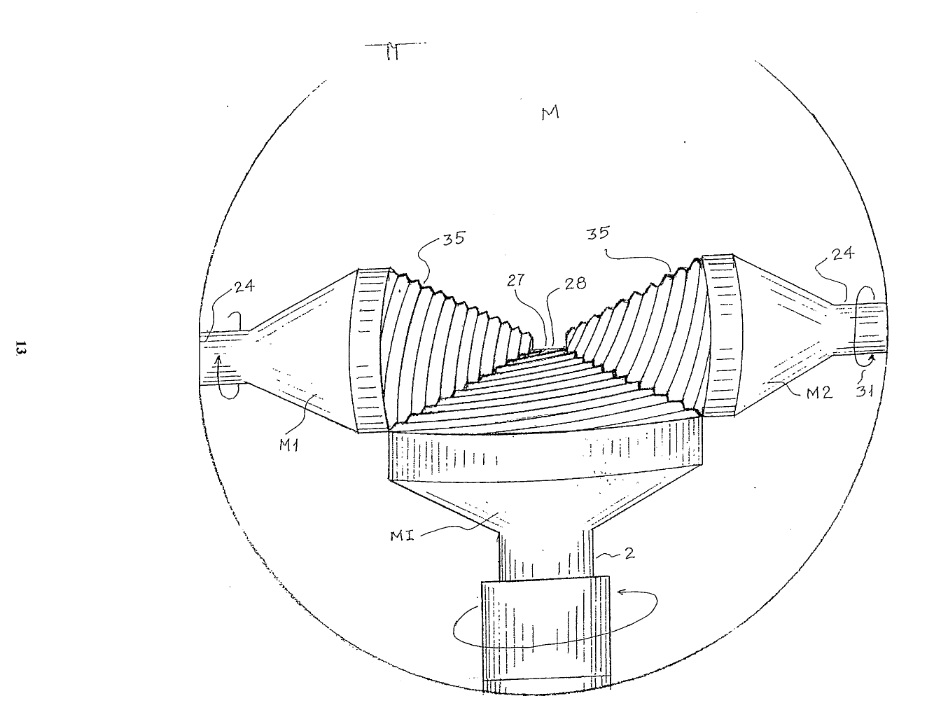

FIG. 13 is the front view of M device, in which reference number 2 denotes the rotating shaft imparting the lifting force from the sphere, MI denotes the bevel gear converging the force imparted from rotating shaft 2; M1 and M2 denote the bevel gears meshed with MI and receive the force imparted from MI, reference number 24 denotes rotating shaft imparting the force in the horizontal direction, reference number 35 denotes the helical recesses (the inclined recesses can be used). Reference number 27 denotes the air pipes, and reference number 28 denotes the electric wire of the motor. Reference number 31 denotes the direction of the rotation of the rotating shafts.

As described above, unit M is the contacting and meshing point of M1 and M2 on MI. The area of the helical recesses, in which bevel gears M1-MI and M2-MI are connected, is very small. Therefore, the friction force caused by M1 and M2 to hold MI is very small while the lifting force F at MI is very high. As a result, static friction is transferred into a sliding friction and rolling friction. Therefore, it is apparent that the lifting force F is higher than the friction force and the rolling friction force will move the contact surface in the opposite direction of the helical recesses, while the rotating shafts is not secured but rotatable around their center axes by the ball bearings. The displacement incurred by turns of the contact surfaces will rotate MI, M1 and M2 around their center axes in the same direction with the helical recesses.

Thanks to this rotation, the vertically lifting force F is transferred into the rotating force F1 and F2 in the horizontal direction from M to M1 and M2. Then, F1 and F2 are transmitted into the turbine of the electric generator.

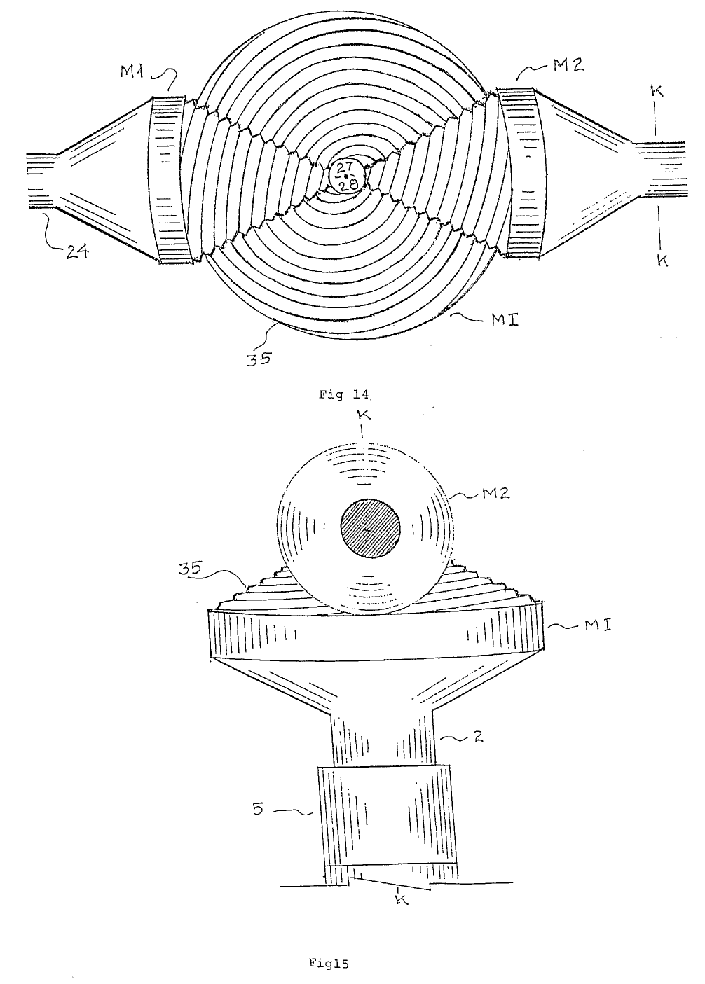

FIG. 14 is the plan view of device M, in which: MI denotes the bevel gear converging the lifting force from the rotating shaft, M1 and M2 denote the bevel gears functioning as meshing points with MI and receiving the force from MI. Reference number 24 denotes the rotating shaft imparting the force in the horizontal direction, K-K denotes the cross section line, reference number 35 denotes the helical recesses; reference number 27 denotes the air pipes, and reference number 28 denotes the electric wire.

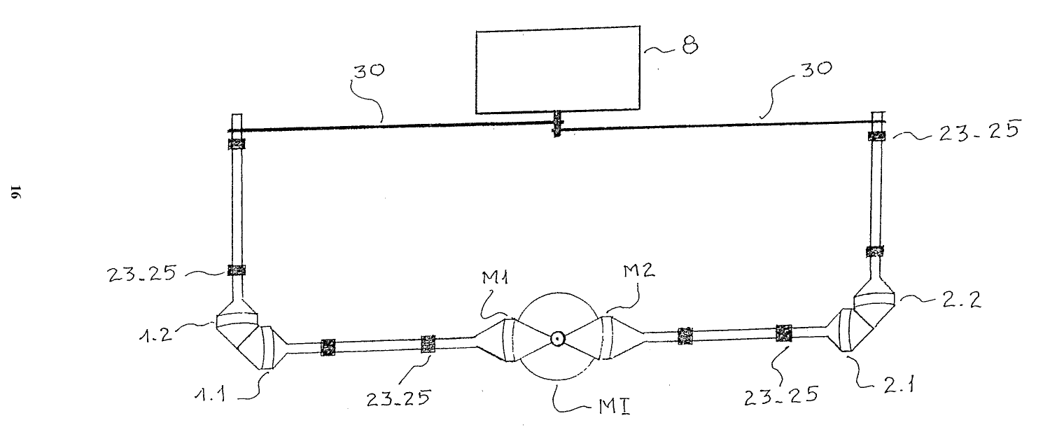

FIG. 15 is a side view of device M along the K-K cross section, in which:

MI denotes the bevel gear converging the lifting force from the rotating shaft 2, M2 is a meshing point with MI and receiving the force from MI; reference number 35 denotes helical recesses, reference number 5 denotes the collar and ball bearings of the rotating shaft 2.

FIG. 16 shows the plan view of the device imparting the force used for generating electricity arranged in the platform, in which: MI denotes the bevel gear converging the lifting force from the sphere, M1 and M2 denote the bevel gears meshed with MI and receive the force imparted from MI. When the rotating shafts rotate around their center axes, force F is exploited and at the same time, transmitted by the rotating shafts M1-1.1 and M2-2.1 to the shafts 1.2 and 2.2 to rotate these shafts; all of the rotating shafts M1-1.1; 1.2 and M2-2.1; 2.2 are supported by the anchored column 23 and the ball bearings 25. The driven rod 30 is disposed at the end part of the rotating shafts 1.1 and 2.2 for connecting to the shaft of the turbine to rotate the electric generator 8.

1. Method of generating electricity by utilizing the Archimedean lifting force and the pressure of the water:
submerging a hollow sphere, with an elastic cover filled by air, into water and maintaining the sphere under the water by a shaft used for imparting force; the sphere is subject not only to the Archimedean lifting force in proportional to the volume thereof but also to water pressure acting on the surface of the sphere, the pressure is in proportion with the height of the water column from the sphere to the surface of the water; the Archimedean lifting force and water pressure result in the lifting force [F] in the vertical direction to buoy the sphere up to the surface of the water;
collecting the lifting force (F) by means of a rotating shaft, the said force (F) is imparted to a unit (M), which is arranged on a platform spaced from the water surface at an appropriate distance, and which includes a plurality of bevel gears which are specifically structured to convert the upwardly vertical force (F) into a plurality of the horizontal rotating forces (F1 and F2);
transmitting the horizontal rotating forces (F1 and F2) via a plurality of the rotating shafts connected with each other in series to rotate a turbine of the electric generator.

2. Device for collecting and imparting the lifting force [F] to unit M and redirecting the lifting force [F] from the vertical direction into the horizontal rotating force [F1 and F2], and then transmitting the rotating forces [F1 and F2] to rotate a turbine of the electric generator, the device includes:
one sphere having an elastic cover [1], the upper part of the sphere is secured by a collar [14] to an end part of a rotating shaft [2], the rotating shaft is inserted through the collar and ball bearings, which are provided at intersections of the supporting and damping rods [4] of the main frame including columns [3] and a platform [10], the end of the rotating shaft [2] is provided with a bevel gear [MI], at which the lifting force from the sphere [1] under the water is converged;
unit [M] includes the bevel gear [MI] for converging the lifting force and the bevel gears [M1 and M2] meshed with the bevel gear [MI] converging the lifting force, the bevel gears [MI, M1 and M2] are provided with the helical recesses [35] [or provided the inclined recesses] converging at the top of the cone, which are fitted in each other at contacting lines of two bevel gears [MI-M1] and [MI-M2]; the bevel gear [M1] is connected to a long rotating shaft having the bevel gear [1.1] provided at the other end, the bevel gear [M2] is connected to a long rotating shaft having the bevel gear [2.1] provided at the other end, the helical recesses of the bevel gear [1.1] are fitted in the helical recesses of bevel gear [1.2], the bevel gear [1.2] is connected to a long rotating shaft having the other end provided with the bevel gear having the parallel recess for mounting a driven rod; similarly, the helical recesses of the bevel gear [2.1] are fitted in the helical recesses of the bevel gear [2.2], the bevel gear [2.2] is connected to a long rotating shaft having the other end provided with a bevel gear with parallel recesses for mounting the driven rod; each of the long rotating shafts [24] are provided with a outer collar [22] and inserted into a collar [26] of ball bearings [25] on the anchored column [23];
when the lifting force from the sphere is higher than the frictions of the bevel gears [M1] and [M2], which occurs at the contact surface of bevel gears [M1′-MI] and [M2-MI], the contact surfaces will be displaced, the displacement causes the rotation of the rotating shaft system;
sphere [1] having the elastic cover, into which a part of the rotating shaft [2] is inserted, the rotating shaft is a hollow body for accommodating air pipes [27] and an electric wire [28] of the motor [11] or dragging line; the horizontal rod [16] is attached to a rotating shaft, which is inserted through the holes of supporting frame [12]; when activating, the supporting frame is erected and air is filled in the sphere [1] via pipe [27] to increase the volume of the sphere and generate the force [F] imparting to the rotating shaft [2] in the upwardly vertical direction;
rotating shaft [2] can be formed by a plurality of the rods depending on the depth of the submergence of the sphere.

3. Sphere [1] according to claim 2, wherein having the cover can be made by rubber, carbon fibre. etc.
